(19) United States
(12) Patent Application Publication
(10) Pub. No.: US 2014/0080572 A1
(43) Pub. Date: Mar. 20, 2014

(54) GAMING SYSTEM, METHOD, AND PROGRAM PRODUCT PROVIDING FULL WINDOW PAYS IN A REEL-TYPE WAGERING GAME

(71) Applicant: Brian Watkins, Austin, TX (US)

(72) Inventor: Brian Watkins, Austin, TX (US)

(21) Appl. No.: 13/623,810

(22) Filed: Sep. 20, 2012

(51) Int. Cl. A63F 13/00

(52) U.S. Cl. 463/20

(57) ABSTRACT

A method includes producing a game symbol matrix for a play in a wagering game. The game symbol matrix is produced through a gaming machine display system by controlling the display system to populate each of at least some of the symbol locations of the game symbol matrix with a respective game symbol selected from one or more game symbol sets. The game symbol matrix is then evaluated for the presence of any winning full window combination, and prizes are awarded at the gaming machine for each winning full window combination defined through the game symbol matrix.

### BACKGROUND OF THE INVENTION

1. Field of the Invention

The present invention relates to wagering games, gaming machines, gaming systems, program products for such gaming machines and gaming systems, and associated methods. More particularly, the invention relates to wagering games which display results through a matrix of symbol locations which are populated with game symbols for a given play of the game, and which define certain winning symbol combinations in terms of the entire set of symbol locations making up the matrix.

2. Description of the Related Art

Numerous types of wagering games have been developed to provide players with new and varied gaming experiences. One of the techniques which has been used to increase player interest in games is to increase the number of chances for a win on a given play of the game. For example, U.S. Pat. No. 5,807,172 shows a reel-type game (a game which displays results via game symbols appearing on a number of mechanical or video-generated spinnable reels) having additional paylines defined through the matrix of reel symbol locations. The three-reel game shown in this patent provides the player with nine paylines and thus nine chances to produce a winning payline rather than the five paylines available in earlier three-reel games. U.S. Pat. No. 5,580,053 discloses another reel-type game in which non-linear paylines are defined in order to increase the number of paylines which may be active for a given play of the game.

U.S. Patent Application Publication No. 2004/0157659 illustrates another technique which has been used to increase the number of paylines in a reel-type game. This technique includes simply using multiple sets of reels in the gaming machine.

Beyond simply increasing the number of chances for a winning combination on a given play of a reel-type game by increasing the number of paylines that may be defined through the reel symbols, prior reel-type games have defined “any pays” to increase the probability of a winning combination along one of the paylines. An “any pay” is a winning combination of symbols along a payline where multiple different game symbols are eligible for forming the symbol combination. An example of an “any pay” is commonly found in games which include single bar, double bar, and triple bar game symbols. An “any pay” for such a game may define a winning combination as, for example, a combination of any bar symbols along a payline defined for the game. One of the problems of “any pay” winning game symbol combinations is that they tend to produce relatively frequent small to mid-level wins.

There remains a need in the field of wagering games to provide gaming machines and methods which capture and maintain the player's interest. In particular, there remains a need in the field of reel-type wagering games, to provide the player with additional ways to win on a given play of the game, and to provide ways for the players to win relatively large prizes.

### SUMMARY OF THE INVENTION

The present invention encompasses methods, apparatus, and program products for providing additional chances for wins in a given play of a reel-type game. More specifically, the invention involves defining one or more winning full window combinations, which are winning combinations of game symbols defined in terms of the entire set of symbol locations making up the game symbol matrix for the reel-type game. As used in this disclosure and the accompanying claims, a winning combination of game symbols is defined in terms of the entire set of symbol locations when the definition requires a particular game symbol at each symbol location in the game symbol matrix. Winning full window combinations are to be distinguished from winning subset combinations which are winning combinations defined in terms of a respective subset of symbol locations in the game symbol matrix. Subset combinations include combinations of game symbols along a payline defined through the game symbol matrix and scatter pays of one or more game symbols scattered through the game symbol matrix.

A method according to some forms of the invention includes producing a game symbol matrix for a play in a wagering game. The game symbol matrix is produced through a gaming machine display system by controlling the display system to populate each of at least some of the symbol locations of the game symbol matrix with a respective game symbol selected from one or more game symbol sets. The game symbol matrix is then evaluated for the presence of any winning full window combination, and prizes are awarded at the gaming machine for each winning full window combination defined through the game symbol matrix.

Some methods according to the present invention may also evaluate the game symbol matrix for the presence of any winning subset combination, and award a prize for each winning subset combination defined through the game symbol matrix. Any winning subset combinations may be defined in the same pay table that defines the winning full window combination or combinations, or may be defined in a second pay table.

A gaming machine according to one embodiment of the present invention includes a display system including at least one display device, a player input system, and at least one processor. One or more memory devices are associated with the processor or processors for storing instructions which are executable to populate the symbol location matrix with game symbols to produce the game symbol matrix, and to evaluate the game symbol matrix for the presence of winning full window combinations as described above. The stored instructions may also be executed to evaluate the game symbol matrix for the presence of any winning subset combinations. Ultimately, the stored instructions are also executed to award a prize for each winning full window combination, and, in some cases, to award a prize for each winning subset combination.

Considering that the present invention may be implemented using one or more general purpose processing devices, the invention also encompasses a program product which may be stored on one or more tangible computer readable data storage devices representing non-transitory media. The program product may include player input program code together with game program code. The player input program code is executable to receive the game play input for a play of the game. The game program code is executable to control the display device for each play of the game and to evaluate the resulting game symbol matrix according to the method described above. In particular, the game program code is executable to cause the display system to display the game symbol matrix and to evaluate the game symbol matrix for the presence of any winning full window combination. Payout program code may be included which is executable to award a prize at least for each winning full window combination produced in the game symbol matrix.

These and other advantages and features of the invention will be apparent from the following description of illustrative embodiments, considered along with the accompanying drawings.

### BRIEF DESCRIPTION OF THE DRAWINGS

FIG. 1 is a view in perspective of the front of a gaming machine which may be employed in embodiments of the present invention.

FIG. 2 is a diagrammatic representation of the gaming machine shown in FIG. 1 showing various components of the gaming machine.

FIG. 3 is a diagrammatic representation of a gaming network in which the present invention may be implemented.

FIG. 4 is a flow diagram illustrating a process flow according to one or more embodiments of the present invention.

FIG. 5 is a representation of a game symbol matrix that may be formed in an embodiment of the present invention.

FIG. 6 is a representation of a pay table that may be defined for a game according to the present invention which produces the game symbol matrix shown in FIG. 5.

FIG. 7 is a representation of another game symbol matrix that may be formed in an embodiment of the present invention.

FIG. 8 is a representation of yet another game symbol matrix that may be formed in an embodiment of the present invention.

### DESCRIPTION OF ILLUSTRATIVE EMBODIMENTS

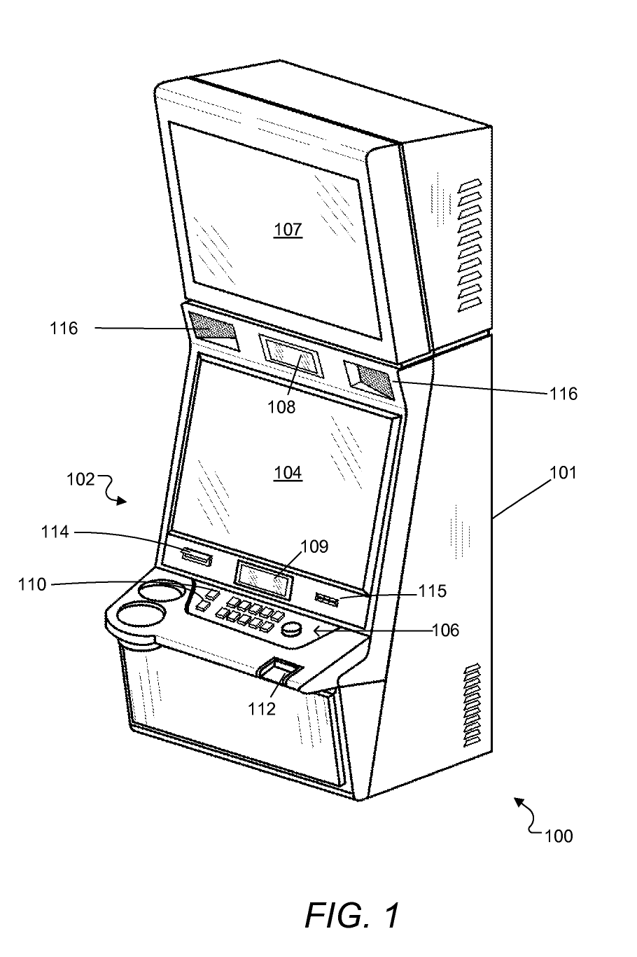

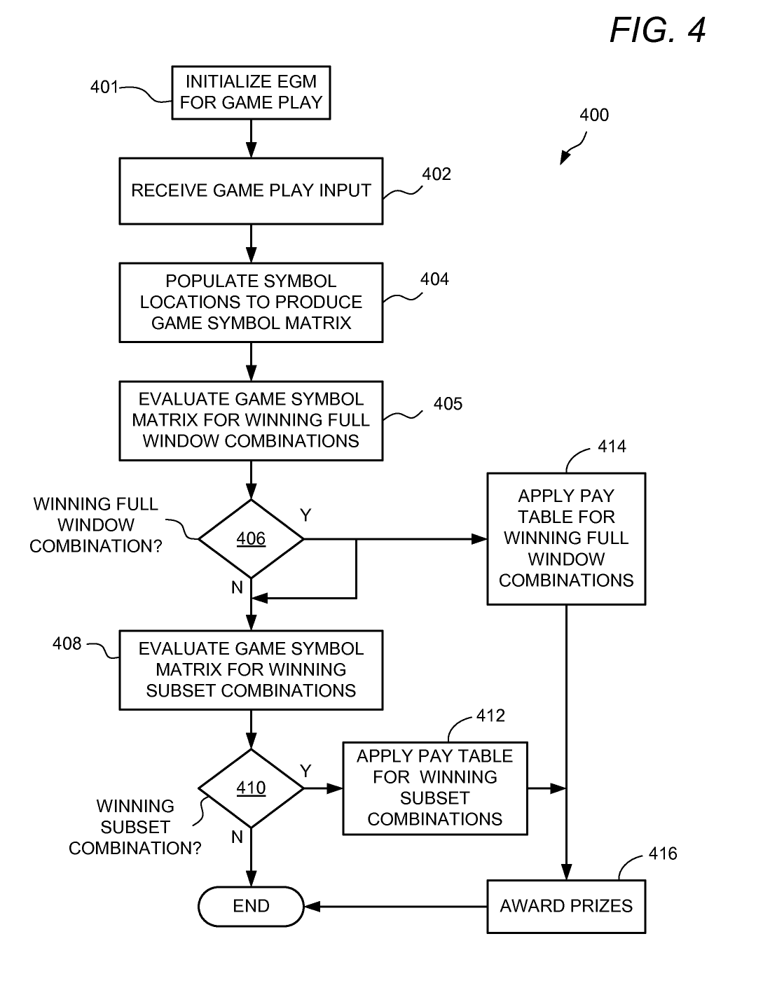

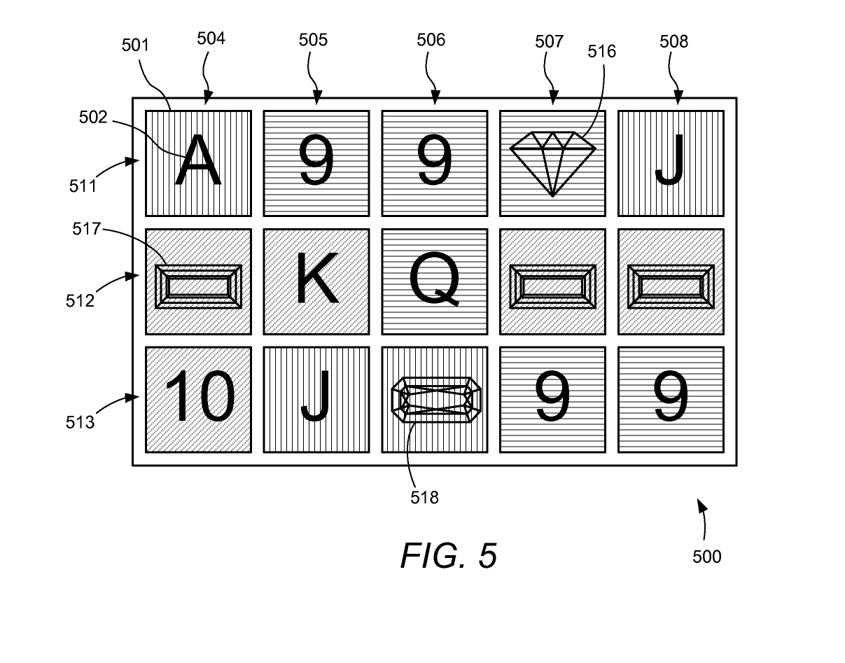

In the following description, FIGS. 1-3 will be used to describe example gaming machines and gaming networks through which the present invention may be implemented. Processes which are illustrative of certain embodiments of the invention will then be described in connection with the flow chart of FIG. 4. Reel-type games embodying the principles of the invention will then be described in connection with FIGS. 5-8.

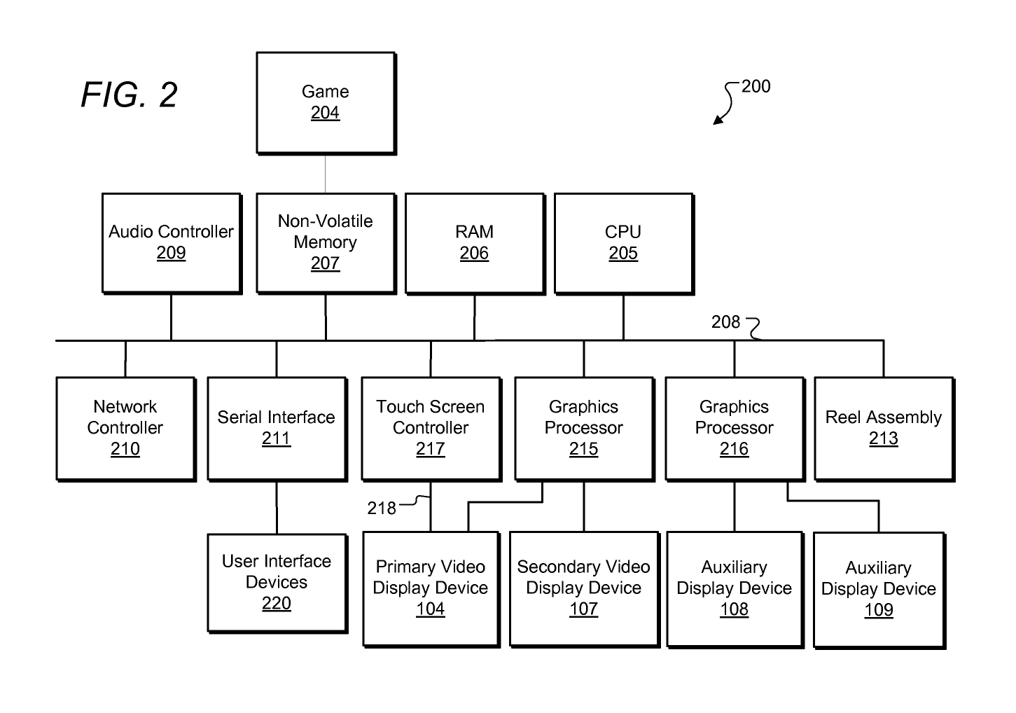

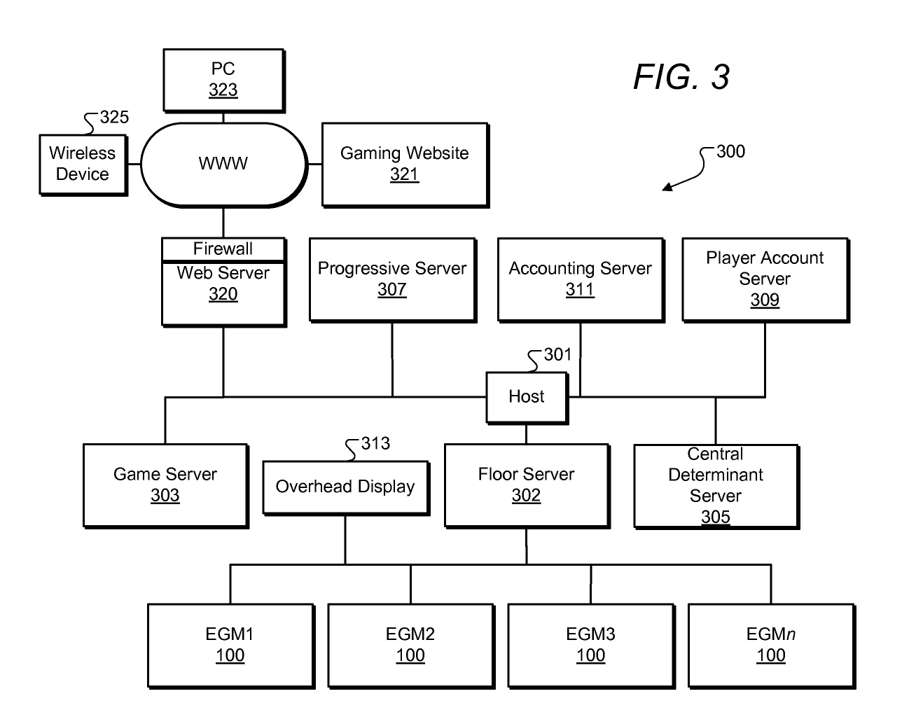

FIG. 1 shows a gaming machine 100 that may be used in implementing a game providing full window combinations according to the present invention. The block diagram of FIG. 2 shows further details of gaming machine 100 along with certain variations which may be included in the gaming machine. FIG. 3 shows an example gaming network in which gaming machines such as gaming machine 100 may be employed.

Referring to FIG. 1, gaming machine 100 includes a cabinet 101 having a front side generally shown at reference numeral 102. A primary video display device 104 is mounted in a central portion of the front side 102, with a button panel 106 positioned below the primary video display device and projecting forwardly from the plane of the primary video display device. In addition to primary video display device 104, the illustrated gaming machine 100 includes a secondary video display device 107 positioned above the primary video display device. Gaming machine 100 also includes two additional smaller auxiliary display devices, an upper auxiliary display device 108 and a lower auxiliary display device 109. It should also be noted that each display device referenced herein may include any suitable display device including a cathode ray tube, liquid crystal display, plasma display, LED display, or any other type of display device currently known or that may be developed in the future. One or more of these video display devices, and especially primary video display device 104, may be used to display game symbols which show the results for a given play of the game implemented through gaming machine 100. Such results may be shown by the manner in which game symbols are aligned along various paylines defined through a symbol location matrix presented by the display device. As will be described further below in connection with FIG. 2 and elsewhere, it is also possible for gaming machines within the scope of the present invention to include mechanical elements such as mechanical reels. Generally, the display device or display devices of the gaming machine, whether video display devices, mechanical devices, or combinations of the two, which are used to display the game symbol matrices according to embodiments of the invention, may be described in this disclosure and the accompanying claims as a display system.

The gaming machine 100 illustrated for purposes of example in FIG. 1 also includes a number of mechanical control buttons 110 mounted on button panel 106. These control buttons 110 may allow a player to select a bet level, select paylines, select a type of game or game feature, and start a play in a game. Other forms of gaming machines through which the invention may be implemented may include switches, joysticks, or other mechanical input devices, and/or virtual buttons and other controls implemented on a suitable touch screen video display. For example, primary video display device 104 in gaming machine 100 provides a convenient display device for implementing touch screen controls in addition to or in lieu of mechanical controls. The player interface devices which receive player inputs to initiate the play of a game through the gaming machine, such as controls to select a wager amount for a given play and control to actually start a given play, may be referred to generally as a player input system.

It will be appreciated that gaming machines may also include a number of other player interface devices in addition to devices that are considered player controls for use in playing a particular game. Gaming machine 100 also includes a currency/voucher acceptor having an input ramp 112, a player card reader having a player card input 114, and a voucher/receipt printer having a voucher/receipt output 115. Numerous other types of player interface devices may be included in gaming machines that may be used to implement embodiments of the present invention.

A gaming machine which may be used to implement embodiments of the present invention may also include a sound system to provide an audio output to enhance the user's playing experience. For example, illustrated gaming machine 100 includes speakers 116 which may be driven by a suitable audio amplifier to provide a desired audio output at the gaming machine.

FIG. 2 shows a logical and hardware block diagram 200 of gaming machine 100 which includes a central processing unit (CPU) 205 along with random access memory (RAM) 206 and nonvolatile memory or storage device 207. All of these devices are connected on a system bus 208 with an audio controller device 209, a network controller 210, and a serial interface 211. A graphics processor 215 is also connected on bus 208 and is connected to drive primary video display device 104 and secondary video display device 107 (both mounted on cabinet 101 as shown in FIG. 1). A second graphics processor 216 is also connected on bus 208 in this example to drive the auxiliary display devices 108 and 109 also shown in FIG. 1. As shown in FIG. 2, gaming machine 100 also includes a touch screen controller 217 connected to system bus 208. Touch screen controller 217 is also connected via signal path 218 to receive signals from a touch screen element associated with primary video display device 104. It will be appreciated that the touch screen element itself typically comprises a thin film that is secured over the display surface of the respective display device, in this case primary video display device 104. The touch screen element itself is not illustrated or referenced separately in the figures.

Those familiar with data processing devices and systems will appreciate that other basic electronic components will be included in gaming machine 100 such as a power supply, cooling systems for the various system components, audio amplifiers, and other devices that are common in gaming machines. These additional devices are omitted from the drawings so as not to obscure the present invention in unnecessary detail.

All of the elements 205, 206, 207, 208, 209, 210, and 211 shown in FIG. 2 are elements commonly associated with a personal computer. These elements may be mounted on a standard personal computer chassis and housed in a standard personal computer housing which itself may be mounted in cabinet 101 shown in FIG. 1. Alternatively, the various electronic components may be mounted on one or more circuit boards housed within cabinet 101 without a separate enclosure such as those found in personal computers. Those familiar with data processing systems and the various data processing elements shown in FIG. 2 will appreciate that many variations on this illustrated structure may be used within the scope of the present invention. For example, since serial communications are commonly employed to communicate with a touch screen controller such as touch screen controller 217, the touch screen controller may not be connected on system bus 208, but instead include a serial communications line to serial interface 211, which may be a USB controller or a IEEE 1394 controller for example. It will also be appreciated that some of the devices shown in FIG. 2 as being connected directly on system bus 208 may in fact communicate with the other system components through a suitable expansion bus. Audio controller 209, for example, may be connected to the system via a PCI or PCIe bus. System bus 208 is shown in FIG. 2 merely to indicate that the various components are connected in some fashion for communication with CPU 205 and is not intended to limit the invention to any particular bus architecture. Numerous other variations in the gaming machine internal structure and system may be used without departing from the principles of the present invention. For example, a gaming machine in some embodiments of the present invention may rely on one or more data processors which are located remotely from the gaming machine itself. Embodiments of the present invention may include no processor such as CPU 205 or graphics processors such as 215 and 216 at the gaming machine, and may instead rely on one or more remote processors. Thus unless specifically stated otherwise, the designation “gaming machine” is used in this disclosure and the accompanying claims to designate a system of devices which operate together to provide the indicated functions. A “gaming machine” may include a gaming machine such as gaming machine 100 shown in FIGS. 1 and 2, which is itself a system of various components, and may also include one or more components remote from a gaming machine cabinet (such as cabinet 101 in FIG. 1). Thus the designation “gaming machine” encompasses both a stand-alone gaming machine and a gaming machine (that is, the part housed in a cabinet such as cabinet 101 in FIG. 1) along with one or more remote components for providing various functions (such as generating outcomes for plays in a game, and driving display devices mounted in a gaming machine cabinet).

It will also be appreciated that graphics processors are also commonly a part of modern computer systems. Although separate graphics processor 215 is shown for controlling primary video display device 104 and secondary video display device 107, and graphics processor 216 is shown for controlling both auxiliary display devices 108 and 109, CPU 205 or a graphics processor packaged with or included with CPU 205 may control all of the display devices directly without any separately packaged graphics processor. The invention is not limited to any particular arrangement of processing devices for controlling the video display devices included with gaming machine 100. Also, a gaming machine implementing the present invention is not limited to any particular number of video display devices or other types of display devices.

In the illustrated gaming machine 100, CPU 205 executes software, that is, program code, which ultimately controls the entire gaming machine including the receipt of player inputs and the presentation of the graphics or information displayed according to the invention through the display devices 104, 107, 108, and 109 associated with the gaming machine. CPU 205 also executes software related to communications handled through network controller 210, and software related to various peripheral devices such as those connected to the system through audio controller 209, serial interface 211, and touch screen controller 217. CPU 205 may also execute software to perform accounting functions associated with game play. Random access memory 206 provides memory for use by CPU 205 in executing its various software programs while the nonvolatile memory or storage device 207 may comprise a hard drive or other mass storage device providing storage for game software such as game program code 204 (and associated program code such as player input program code and payout program code) prior to loading into random access memory 206 for execution, or for programs not in use or for other data generated or used in the course of gaming machine operation. Network controller 210 provides an interface to other components of a gaming system in which gaming machine 100 may be included. An example network will be described below in connection with FIG. 3.

It should be noted that the invention is not limited to gaming machines employing the personal computer-type arrangement of processing devices and interfaces shown in example gaming machine 100. Other gaming machines through which the invention may be implemented may include one or more special purpose processing devices to perform the various processing steps for implementing the invention. Unlike general purpose processing devices such as CPU 205, which may comprise an Intel® Pentium® or Core® processor for example, these special purpose processing devices may not employ operational program code to direct the various processing steps.

The example gaming machine 100 which may be used to implement some embodiments of the present invention is shown in FIG. 2 as including user interface devices 220 (part of a player input system) connected to serial interface 211. These user interface devices may include various player input devices such as mechanical buttons shown on button panel 106 in FIG. 1, and/or levers, and other devices. It will be appreciated that the interface between CPU 205 and other player input devices such as player card readers, voucher readers or printers, and other devices may be in the form of serial communications. Thus serial interface 211 may be used for those additional devices as well, or the gaming machine may include one or more additional serial interface controllers. However, the interface between peripheral devices in the gaming machine, such as player input devices, is not limited to any particular type or standard for purposes of the present invention.

Reel Assembly 213 is shown in the diagrammatic representation of FIG. 2 to illustrate that a gaming machine which may be used for various embodiments of the invention may include mechanical reels. For example, a set of mechanical reels may replace the primary display device 104, or at least part of that display device. Alternatively, mechanical reels may be included in the gaming machine behind a light-transmissive video display panel. In either case, the mechanical reels represent a display device for displaying some or all of the game symbols in the course of a game play. Although the invention is not limited to any particular mechanical reel arrangement or control system, mechanical reels may be controlled conveniently through serial communications which provide instructions for a respective stepper motor for each reel. Thus some embodiments of the present invention which employ mechanical reels may use a serial interface device such as serial interface 211 to control communications with the reel assembly, and may not include a direct bus interconnection as indicated by FIG. 2. Details of a mechanical reel arrangement and various accent lighting arrangements which may be associated with mechanical reels are not shown in the present figures so as to avoid obscuring the present invention in unnecessary detail.

Referring now to FIG. 3, a networked gaming system 300 associated with one or more gaming facilities may include one or more networked gaming machines 100 (“electronic gaming machines” or “EGM's”) connected in the network by suitable network cable or wirelessly. Networked gaming machines 100 (EGM1-EGMn) and one or more overhead displays 313 may be operatively connected so that the overhead display or displays may mirror or replay the content of one or more displays of gaming machines 100. For example, the primary display content for a given gaming machine 100 may be stored by a display controller or game processor 205 of the given gaming machine and transmitted through network controller 210 to a controller associated with the overhead display(s) 313. In the event gaming machines 100 have cameras installed, the respective player's video images may be displayed on overhead display 313 along with the content of the player's gaming machine display.

The example gaming network 300 shown in FIG. 3 includes a host server 301 and floor server 302, which together may function as an intermediary between floor devices such as gaming machines 100 and back office devices such as the various servers described below. Game server 303 may provide server-based games and/or game services to network connected gaming devices such as gaming machines 100. Central determinant server 305 may be included in the network to identify or select lottery, bingo, or other centrally determined game outcomes and provide the information to networked gaming machines 100 which present the games to the players.

Progressive server 307 may accumulate progressive prizes by receiving defined amounts, such as a percentage of the wagers from eligible gaming devices or by receiving funding from marketing or casino funds. Progressive server 307 may also provide progressive prizes to winning gaming devices in response to a progressive event. Such a progressive event may comprise, for example, a progressive jackpot game outcome or other triggering event such as a random or pseudo-random win determination at a networked gaming device or server. Accounting server 311 may receive gaming data from each of the networked gaming devices, perform audit functions, and provide data for analysis programs. Player account server 309 may maintain player account records, and store persistent player data such as accumulated player points and/or player preferences (for example, game personalizing selections or options).

Example gaming network 300 also includes a gaming website 321 which may be hosted through web server 320 and may be accessible by players via the Internet. One or more games may be displayed as described herein and played by a player through a personal computer 323 or handheld wireless device 325 (for example, a Blackberry® cell phone, Apple® iPhone®, personal digital assistant (PDA), iPad®, etc.). To enter website 321, a player may log in with a user name that may, for example, be associated with the player's account information stored on player account server 309. Once logged onto website 321 the player may play various games on the website. Also website 321 may allow the player to make various personalizing selections and save the information so it is available for use during the player's next gaming session at a casino establishment having the gaming machines 100.

It will be appreciated that gaming network 300 illustrated in FIG. 3 is provided merely as an example of a gaming network in which games featuring winning full window combinations according to embodiments of the present invention may be implemented, and is not intended to be limiting in any way. The invention is not limited to use in games offered through a gaming network (via the gaming website 321, or via gaming machines such as gaming machines 100, or otherwise). For example, games including full window combinations according to the present invention may be offered through a stand-alone gaming machine having a configuration similar to gaming machine 100 or having any other gaming machine configuration. Also, where games including full window combinations as described particularly below in connection with FIGS. 4-8 are offered through gaming machines included in a gaming network, the network need not have the configuration shown for purposes of example in FIG. 3. In particular, servers shown separately in the example of FIG. 3 may be combined in a single physical processing device, or the processing duties of the various illustrated servers may be split into additional physical devices.

FIG. 4 illustrates an example process within the scope of the present invention. The process shown in FIG. 4 from process block 402 through 416 represents a single game play according to one form of the invention and thus may be repeated for each respective play of the game. The illustrated process applies to a reel-type wagering game in which the results for a play of the game are shown by the manner in which symbol locations are populated with game symbols by spinning video-generated or mechanical reels and then bringing the reels to a stop to show a respective game symbol at each symbol location of a matrix. The following paragraph will describe the overall process shown in FIG. 4 and then subsequent paragraphs will describe the individual process steps in greater detail, and describe certain variations on these steps.

As shown at process block 401, the electronic gaming machine (such as gaming machine 100 in FIGS. 1-3) is first initialized for game play. Once the gaming machine is initialized, the process may include receiving a game play input as indicated at process block 402, and then populating the matrix of game symbol locations as indicated at process block 404. Once all of the intended symbol locations are populated with a respective game symbol, or at least once the game symbols assigned to the various symbol locations are known, the process evaluates the resulting matrix for the presence of winning full window combinations of game symbols as indicated at process block 405. If no winning full window combination is detected as indicated by a negative outcome at decision box 406, the illustrated example process branches to evaluate the game symbol matrix for winning subset combinations according to the applicable pay table as indicated at process block 408. If winning subset combinations are detected as indicated by an affirmative outcome at decision box 410, the applicable pay table is applied to identify the winning subset combination prizes as indicated at process block 412, and the process awards any such prizes accordingly as indicated at process block 416. However, if a winning full window symbol combination is detected as indicated by an affirmative outcome at decision box 406, the process both continues through process block 410 and also process branches to apply the applicable pay table to identify the prize correlated to each detected full window combination as indicated at process block 414. Each full window combination prize is awarded along with any subset combination prize as shown at process block 416. The process then ends from either a negative outcome at decision box 410 or once prizes have been awarded as indicated at process block 416 for that particular game sequence. As noted above, the process steps from 402 to 416 may be repeated for each subsequent game play input or activation in a gaming session by a player at the gaming machine.

The process of initializing a gaming machine for play of the game as indicated at process block 401 may include a number of different steps depending upon the nature of the gaming machine and the gaming network in which the gaming machine may be included. For example, many modern gaming machines may require a player login to initialize the gaming machine for play. This login may include receiving a player identifier at the gaming machine in some fashion either through a card reader or other reading device or input device at the gaming machine. Other gaming machines may require no player login, but may require the player to insert cash or credits into the gaming machine in some fashion to initialize the gaming machine for play. For example, in ticket-in-ticket-out systems, a player may be required to insert a ticket into a ticket reader at the gaming machine to place credits on the gaming machine to facilitate play. Where the gaming machine accepts cash, the initialization process may include receiving cash from the player. Process block 401 is included in FIG. 4 simply to indicate that typically the gaming machine must be initialized for game play in some fashion, but is not intended to limit the invention to any particular type of initialization.

In some forms of the invention the process of initializing the gaming machine for play as indicated at process block 401 causes the gaming machine to display a symbol display area on a symbol display device of the gaming machine. The symbol display area includes a number of symbol locations for a wagering game. The state of this symbol display area (that is, the particular game symbols displayed in the symbol locations) may simply be left over from the immediately preceding play of the game. In other embodiments, the state of the symbol display area may be left over from an attract sequence executed by the gaming machine to attract a player to that particular machine. Yet other forms of the invention may return the symbol display area to a particular starting condition for each play the game.

The game play input received as indicated at process block 402 may include receiving a number of separate inputs to initiate the play of the game. For example, a player may be required to select a bet level for the play and/or may be required to select which symbol location combinations (paylines in reel-type games) are active for the given play. The present invention is not limited to receiving any particular input or inputs to initiate the play of the game. Unless stated specifically otherwise, for the purpose of this disclosure and the following claims, the step of receiving a game play input includes receiving any single input or sequence of inputs to initiate the play of the game.

It will also be appreciated that the process shown in FIG. 4 is not limited to plays in a primary game offered through a gaming machine. Rather, the process may be applied to secondary games, bonus games, free games, and other levels and types of games available through the gaming machine. In cases where winning full window symbol combinations are applied to a bonus game or secondary game which is entered after or during a play in a primary game and perhaps in other instances, the step of populating the symbol location matrix as indicated at process block 404 may not be performed in response to a game play input received as indicated at process block 402. Also, a game play input which prompts the process shown at process block 404 may be an input in another game such as a primary game. A primary game in this instance or in other instances may not include winning full window symbol combinations. That is, different levels of related games at a gaming machine may or may not all include winning full window symbol combinations.

The process of populating the symbol locations with respective game symbols according to process block 404 may be accomplished in a number of different ways within the scope of the present invention. Where the gaming machine includes mechanical reels, at least some symbol locations may be populated by spinning the reels and then bringing each reel to a stop to show a respective game symbol at each symbol location. Video reel-type games include a video simulation of reels (which may be shown on video display device 104 in FIG. 1 for example) which spin and then come to a stop to show various game symbols in the symbol location matrix. The invention is not limited to any particular reel arrangement, for either a mechanical reel or video reel implementation.

It should be appreciated that some forms of the invention may not change all of the symbols for a given play of the game. For example, one or more of the mechanical or video-generated reels may remain stationary for a given play. Such stationary reels may be selected randomly, may be selected under the control of the player in some fashion, may be selected based on a previous play of the game, or may be selected in any other fashion. Where the player may select symbol locations to remain constant over the course of the given play of the game, the selection may be part of the game play input at process block 402, for example.

The invention is not limited to any particular arrangement for selecting the game symbols to be displayed in the various symbol locations of the symbol location matrix for a given play of the game in accordance with process block 404. In a central determinant system, such as a central determinant bingo or electronic lottery system, for example, a given play of the game may be associated with one or more outcomes of the underlying game. In these cases, each reel may be forced to stop at the desired angular orientation to display game symbols consistent with the outcome of the underlying game or a random outcome selection. In other forms of the invention the outcome for a given play of the game is obtained in some fashion at the gaming machine itself and the reels are forced to stop showing game symbols consistent with the outcome. In yet other forms of invention, the reels may be stopped randomly or pseudo-randomly to populate the symbol locations which are to be populated for the given play of the game. For example, each reel stop position may be associated with a probability of landing at that position, and probabilities may be used to produce a number range which correlates each reel stop position to a portion of the number range. The process of stopping the given reel may include randomly or pseudo-randomly generating a number in the number range and using that generated number to identify a stop position for the reel.

The process of evaluating the game symbol matrix for any winning full window combinations as shown in process block 405 may be accomplished in any suitable fashion. The evaluation may involve comparing the various game symbols in the game symbol matrix to the full window symbol combinations defined in the applicable pay table for the game to determine if a given displayed game symbol matrix matches one of the winning full window symbol combinations defined in the pay table. The game symbols appearing in the game symbol matrix may be apparent from the angular position of the reel or virtual reel, or may be apparent from the result which forces the reels to stop at the given positions. Alternatively, each winning full window symbol combination defined in the pay table may be correlated to a set of reel stop positions which produce the symbol combination, and these reel stop positions may be stored in a data table. In this alternative, the evaluation may include comparing the reel stop positions for the game symbol matrix to the stored reel stop positions to identify a match. Such a match indicates that the game symbol matrix produces the full window symbol combination correlated to the matched reel stop positions.

The same techniques may be applied to performing the evaluation for winning subset combinations according to process block 408. However, in the case of process block 408, the applicable pay table will define winning subset combinations of game symbols rather than full window combinations.

The process of applying the pay table for winning subset combinations and winning full window combinations according to process blocks 408 and 414, respectively, may involve any suitable process. For example, each winning symbol combination detected at process blocks 405 and 410 may be associated with a prize value through a suitable data table. In this case, applying the pay table involves reading the associated prize value from the data table and adding that winning prize amount (in the applicable units) to a total amount for that play of the game. This total amount in credits, currency, physical merchandise (or vouchers for such merchandise), or combinations of these or other units may then be awarded to the player in a suitable manner according to the step at process block 416.

The prizes that may be awarded in accordance with process block 416 may be awarded in any particular fashion consistent with the particular gaming machine and gaming system. For example, prizes are awarded in some gaming machines by increasing the credit value on the gaming machine and the player may cash out from that gaming machine to obtain value for those credits. Other types of gaming systems maintain an account for the player's play at a remote accounting system, and the prizes are awarded by crediting the player's remote account and showing the updated account value at the gaming machine. Some types of prizes may be hand pay prizes which require a casino employee to manually deliver the prize or a voucher for the prize to the player. Hand pays are typically required for high-value prizes or for prizes in the form of merchandise or coupons. Other types of gaming machines may physically dispense prizes in the form of coins or other value. The invention is not limited to any particular system or arrangement for awarding the prizes for wins according to the applicable pay table or pay tables for the game.

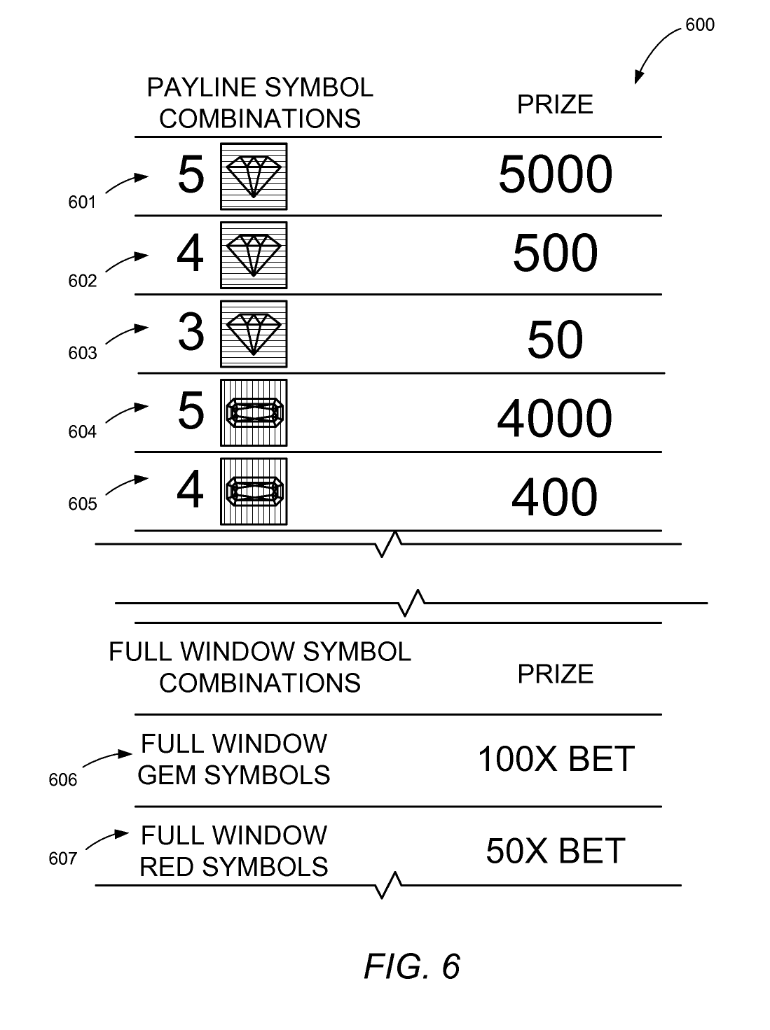

Specific examples of a process according to the invention may be described with reference to FIGS. 5 through 8. FIGS. 5, 7, and 8 each illustrate an example game symbol matrix which may be produced in accordance with the process block 404 in FIG. 4, while FIG. 6 illustrates a pay table which may be applied to each game symbol matrix in accordance with process blocks 405, 408, 412, and 414 of FIG. 4.

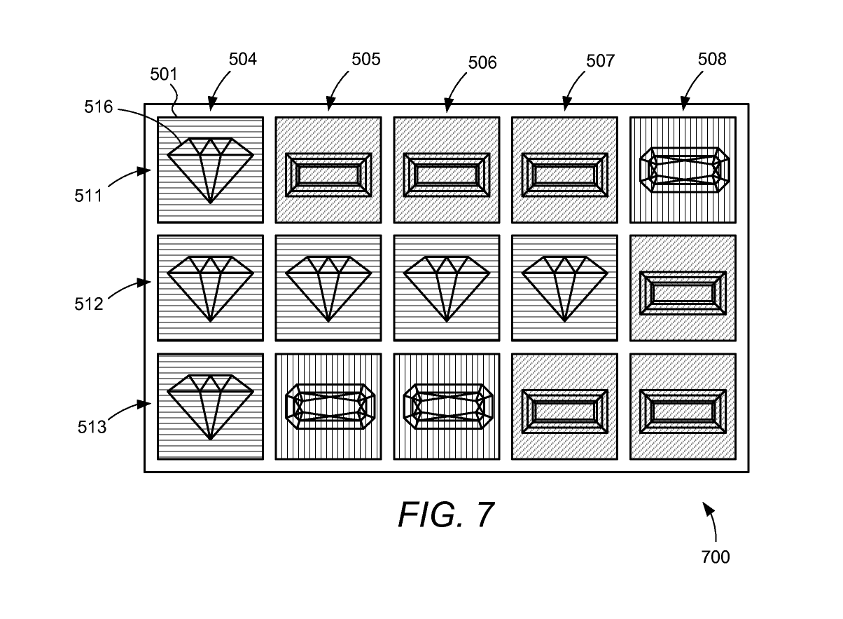

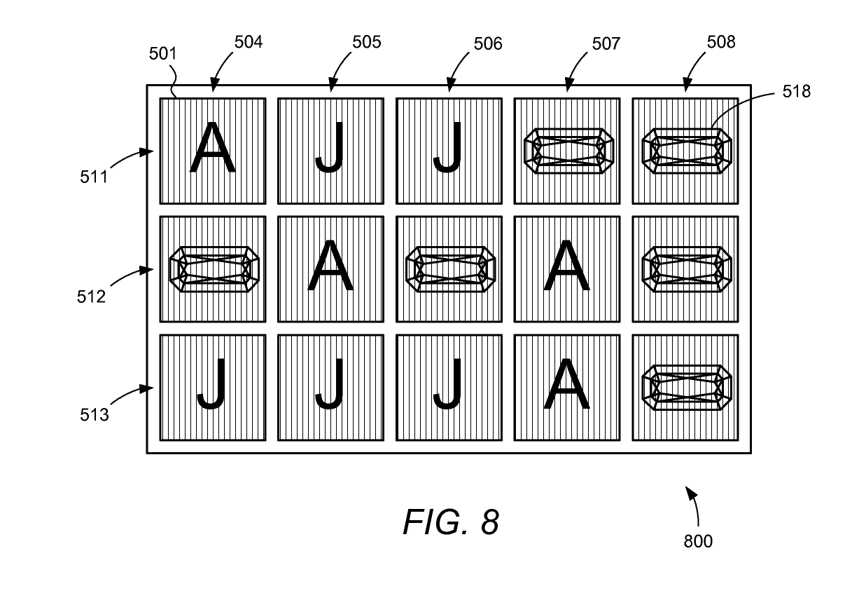

Referring to FIG. 5, the game symbol matrix 500 is made up of a number of symbol locations 501, each populated with a respective game symbol 502, and aligned in five vertical columns 504, 505, 506, 507, and 508, and three horizontal rows 511, 512, and 513. It should by assumed for the purposes of the example shown in FIG. 5 (and the examples of FIGS. 7 and 8 as well) that this particular 5×3 matrix of symbol locations 501 is displayed with a five reel, reel-type gaming machine where each reel, either mechanically or video-generated, displays one of the three-symbol, vertical columns of the matrix (namely, columns 504, 505, 506, 507, and 508). Each of the reels which shows a respective column of symbol locations may be either mechanical or video-generated, and the reels are aligned side-by-side along a horizontal axis of rotation in the orientation of the figures.

For purposes of the example game symbol matrices shown in FIGS. 5, 7, and 8, it should be assumed that the game includes a universe of game symbols including three different gem symbols each associated with a different color, and the symbols Ace (“A”), King (“K”), Queen (“Q”), Jack (“J”), ten (“10”), and nine (“9”), with each symbol associated with a color. The colors are indicated by different crosshatching, with the vertical crosshatching indicating the color red, horizontal crosshatching indicating the color blue, and diagonal crosshatching indicating the color green. Thus the Ace and Jack symbols are associated with the color red, the King and ten symbols are associated with the color green, and the Queen and nine symbols are associated with the color blue. The gem symbol shown in FIG. 5 at the intersection of column 507 and row 511 comprises a sapphire symbol 516 associated with the color blue. The gem symbol at the intersection of column 504 and row 512 in FIG. 5 comprises an emerald symbol 517 associated with the color green. Finally, the gem symbol at the intersection of column 506 and row 513 in FIG. 5 comprises a ruby symbol 518 associated with the color red.

The pay table 600 shown in FIG. 6 includes a number of winning subset combinations, examples of which are shown in the first five lines of the pay table, lines 601 through 605. For example, line 601 defines the winning subset combination of five sapphire symbols correlated with a prize of 5000 units, line 602 defines the winning subset combination of four sapphire symbols correlated to the prize of 500 units, and line 605 defines the winning subset combination of four ruby symbols correlated with the prize of 400 units. It will be appreciated that the pay table continues on with other definitions of winning subset combinations made up of the emerald symbol 517, and the card-based symbols, however, these additional winning subset combinations are omitted from FIG. 6 in order to simplify the description of the present invention. Pay table 600 also includes two lines 606 and 607 of winning the full window symbol combinations. In particular line 606 defines a winning full window symbol combination as a full window of gem symbols (including any combinations of the sapphire 516, emerald 517, and ruby 518 symbols). This full window gem symbol combination correlates to the prize of one hundred times the bet for the given play of the game. Line 607 defines a winning full window combination comprising all red symbols, and correlates to the prize of fifty times the bet for the given play of the game.

For purposes of the examples of FIGS. 5, 7, and 8 it should further be assumed that the subset combinations defined in pay table 600 of FIG. 6 pay only for horizontal paylines, that is, consecutive symbols aligned on one of the rows 511, 512, or 513. Furthermore, as is common in reel-type games, the winning subset combinations must be left-to-right symbol combinations originating with the first symbol on the left, column 504. It will be appreciated that reel-type games commonly define numerous paylines other than horizontal paylines. However, the limitation to horizontal paylines for purposes of these examples is made in order to simplify the discussion. The invention certainly is not limited to any particular subset combinations defined through a game symbol matrix, and is not limited to any particular manner of reading the symbols left-to-right, or right-to-left, or otherwise.

With all these assumptions in mind and referring to game symbol matrix 500 in FIG. 5 and pay table 600 in FIG. 6, it will be noted that game symbol matrix 500 does not produce any winning combination of game symbols. That is, it does not include any winning subset combination or any winning full window combination shown in pay table 600. Thus if matrix 500 is produced for a game in accordance with process block 404 in FIG. 4, the matrix evaluations would produce negative outcomes at decision boxes 406 and 410, and the game sequence would end without the award of any prize.

Unlike game symbol matrix 500 shown in FIG. 5, game symbol matrix 700 shown in FIG. 7 includes both a winning full window combination and a winning subset combination according to pay table 600 shown in FIG. 6. In particular, matrix 700 is made up exclusively of gem symbols and thus meets the full window gem symbol combination definition shown at line 606 of FIG. 6. This full window gem symbol combination entitles the player to a win of one hundred times the bet according to pay table 600. Additionally, matrix 700 includes a winning subset combination of four sapphire symbols in the middle row, row 512. This winning subset combination entitles the player to a prize of 500 units according to pay table 600.

It should be noted from FIG. 7 that the reel which produces the first column of symbols, column 504, includes a section of adjacent (stacked) sapphire symbols 516 in order to produce the three consecutive vertically aligned sapphire symbols shown in this example. The reels, whether video-generated reels or mechanical reels, may include these types of stacked symbols in order to help facilitate producing both winning full window combinations and winning subset combinations. The stacked sapphire symbols 516 shown in FIG. 7 help facilitate both the full window gem symbol combination defined at line 606 of pay table 600 and would also help facilitate a winning full window combination defined as a full window of blue symbols. Of course the stacked sapphire symbols 516 also help produce consecutive horizontal subset combinations as well.

Referring now to FIG. 8, this last example game symbol matrix 800 comprises an arrangement of game symbols that also produces a winning full window combination according to pay table 600 shown in FIG. 6. In particular, all of the game symbols shown in matrix 800 are associated with the color red. This result would entitle the player to win a prize of fifty times the bet according to pay table 600. Matrix 800 also happens to include a winning subset combination of three Jacks along the horizontal payline defined by row 513 (this consecutive Jack symbol winning subset combination is assumed to be included in the portion of pay table 600 not shown in FIG. 6).

It may be noted from matrix 800 shown in FIG. 8 that the fifth reel, the reel producing symbol location column 508 includes stacked ruby symbols 518 similar to the stacked sapphire symbols 516 shown in FIG. 7. This stack of three ruby symbols 518 on the reel helps facilitate the full window winning combination defined at line 607 of pay table 600, and could also facilitate a full window gem symbol combination as defined at line 606 of pay table 600. It will further be noted that all of the reels include stacks of at least three adjacent red symbols in order to facilitate the winning full window combination defined at line 607 of pay table 600. This stacked symbol arrangement is required for winning full window symbol combinations such as that defined at line 607 of pay table 600 where the reels show game symbols for multiple symbol locations, and the symbols on the reels cannot be modified during the course of a play.

Implementations of the invention providing winning full window symbol combinations are certainly not limited to the examples described above in connection with the game symbol matrices shown in FIGS. 5, 7, and 8, and pay table 600 shown in FIG. 6. Rather, embodiments of the invention are subject to wide variation within the scope of the following claims. For example, alternatively to the assumed five-reel, multi-symbol per reel configuration shown in the figures, at least some symbol locations may be shown with a separate reel which populates only that symbol location. In these unisymbol reel arrangements, it will be appreciated that it is not necessary to stack symbols to facilitate the winning full window symbol combinations such as those described at lines 606 and 607 in FIG. 6. It is also possible within the scope of the present invention that arrangements other than side-by-side vertically oriented reels may be used to populate the various symbol locations with a respective game symbol. Reels may be arranged to spin about a vertical axis, or spinnable wheels may be arranged to populate the symbol locations. Also, arrangements of game symbols that travel in noncircular paths may be used to populate the symbol locations. Of course, embodiments of the invention are not limited to a 3×5 matrix or any particular number of multiple row and multiple columns. The invention is also not limited to any particular types or amounts of prizes for the winning full window symbol combinations or other combinations defined in the applicable pay table or tables. Prizes may be expressed in terms of credits, cash, merchandise, or in any other units, and may also be progressive prizes. One of the advantages of winning full window symbol combinations is that the combinations may be set up to hit relatively infrequently, and thus relatively large prizes may be correlated to such combinations. Also, the presence of a large prize for a winning full window symbol combination and the fact that a game may produce many near misses for such a combination may make games incorporating such winning combinations exciting for players and observers.

Other variations from the examples of FIGS. 5 through 8 may be associated with the pay table and with the game symbols used to populate the various symbol locations. For example, although pay table 600 in FIG. 6 includes both winning full window symbol combinations and subset symbol combinations, implementations of the invention may use separate pay tables for these two types of winning symbol combinations. Furthermore, embodiments of the invention may also include scatter pays which define prizes in terms of some number of symbols or symbol combinations appearing at any symbol locations in the matrix, and not just symbol combinations aligned along a payline. Also, the invention is not limited to any symbols or symbol groups. Some implementations may use different symbol groups for populating different symbol locations in the symbol location matrix. For example, rather than a universal set of game symbols such as that described above in connection with FIGS. 5 through 8, some reels of a reel type game may include only a subset of the game symbols used in the game. The reel producing column 504 in FIG. 5, for instance, may include only sapphire symbols 516 and the other non-gem symbols in the symbol set, but no other types of gem symbols. Of course, symbol sets used to populate the various symbol locations may include wild symbols and other symbols having special significance.

Although example implementations of the invention are described above mostly in terms of standalone games, it should be appreciated that the invention may be applied in any number of different gaming environments and/or in combination with other games. For example, games providing winning full window symbol combinations according to the present invention may be used as in-revenue or out-of-revenue tournament games or in side action games that are played in parallel or concurrently with one or more other games. Games employing full window symbol combinations may also be employed as community games in which results at one gaming machine affect a community of one or more other players at different gaming machines. Games employing full window symbol combinations may also employ additional features to enhance the player's gaming experience. For example, players may be allowed to save game symbols from one play (including trigger symbols) and apply the saved symbols to another play. This may be accomplished by freezing one or more reels for a given play of a reel-type game. Also, games employing full window symbol combinations may incorporate progressive prizes. For example, one or more prizes in the applicable pay table may comprise a respective progressive prize. Avatars are among other game features which may be used in connection with games employing full window symbol combinations. Trailing touch screen graphic effects such as those disclosed in U.S. Patent Application Publication No. 2012/0115599 may also be incorporated in games employing full window symbol combinations.

As used in the foregoing description and the following claims, the terms “comprising,” “including,” “carrying,” “having,” “containing,” “involving,” and the like are to be understood to be open-ended, that is, to mean including but not limited to. Any use of ordinal terms such as “first,” “second,” “third,” etc., in the claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

The above-described example embodiments are intended to illustrate the principles of the invention, but not to limit the scope of the invention. Various other embodiments and modifications to these preferred embodiments may be made by those skilled in the art without departing from the scope of the present invention.

1. A method for controlling payouts in a reel-type wagering game in which results are displayed graphically through a matrix of game symbol locations where each game symbol location may be populated by a respective game symbol, the method including:
(a) for a play in the wagering game, producing a game symbol matrix through a gaming machine display system, the game symbol matrix being produced by controlling the display system to populate each of at least some of the symbol locations of the game symbol matrix with a respective game symbol selected from one or more game symbol sets;
(b) evaluating the game symbol matrix for the presence of any winning full window combination, each winning full window combination being defined in a first pay table in terms of the entire set of symbol locations making up the game symbol matrix; and
(c) awarding a prize at the gaming machine for each winning full window combination defined through the game symbol matrix.

2. The method of claim 1 further including:
(a) evaluating the game symbol matrix for the presence of any winning subset combination, each winning subset combination being defined in the first pay table or a second pay table in terms of a respective subset of symbol locations in the game symbol matrix; and
(b) awarding a prize for each winning subset combination defined through the game symbol matrix.

3. The method of claim 1 wherein each winning full window combination requires a respective game symbol of a predefined game symbol type at each game symbol location of the game symbol matrix.

4. The method of claim 3 wherein the predefined game symbol type includes a particular game symbol graphic representation.

5. The method of claim 3 wherein the predefined game symbol type includes a particular game symbol color.

6. The method of claim 1 wherein one or more reels of the reel-type wagering game include a series of adjacent symbols of matching game symbol type.

7. The method of claim 6 wherein the series of adjacent symbols of matching game symbol type are different game symbols having a common game symbol color.

8. A reel-type gaming machine including:
(a) a display system;
(b) a player input system;
(c) at least one processor; and
(d) at least one memory device storing instructions executable by the at least one processor to:
(i) cause the display system to display a game symbol matrix made up of a number of game symbol locations, and to display each of at least some of the symbol locations of the game symbol matrix with a respective game symbol selected from one or more game symbol sets;
(ii) evaluate the game symbol matrix for the presence of any winning full window combination, each winning full window combination being defined in a first pay table in terms of the entire set of symbol locations making up the game symbol matrix; and
(iii) award a prize for each winning full window combination defined through the game symbol matrix.

9. The gaming machine of claim 8 wherein the instructions are also executable by the at least one processor to:
(a) evaluate the game symbol matrix for the presence of any winning subset combination, each winning subset combination being defined in the first pay table or a second pay table in terms of a respective subset of symbol locations in the game symbol matrix; and
(b) award a prize for each winning subset combination defined through the game symbol matrix.

10. The gaming machine of claim 8 wherein each winning full window combination requires a respective game symbol of a predefined game symbol type at each game symbol location of the game symbol matrix.

11. The gaming machine of claim 10 wherein the predefined game symbol type includes a particular game symbol graphic representation.

12. The gaming machine of claim 10 wherein the predefined game symbol type includes a particular game symbol color.

13. The gaming machine of claim 8 wherein one or more reels of the reel-type gaming machine include a series of adjacent symbols of matching game symbol type.

14. The gaming machine of claim 13 wherein the series of adjacent symbols of matching game symbol type are different game symbols having a common game symbol color.

15. A program product stored on one or more non-transitory computer readable data storage devices, the program product including:
(a) player input program code executable by at least one processor to receive a game play input entered through a player input system of a gaming machine;
(b) game program code executable by the at least one processor to:
(i) cause a display system to display a game symbol matrix made up of a number of game symbol locations, and to display each of at least some of the symbol locations of the game symbol matrix with a respective game symbol selected from one or more game symbol sets; and
(ii) evaluate the game symbol matrix for the presence of any winning full window combination, each winning full window combination being defined in a first pay table in terms of the entire set of symbol locations making up the game symbol matrix; and
(c) payout program code executable by the at least one processor to award a prize for each winning full window combination defined through the game symbol matrix.

16. The program product of claim 15 wherein the game program code is also executable to:
(a) evaluate the game symbol matrix for the presence of any winning subset combination, each winning subset combination being defined in the first pay table or a second pay table in terms of a respective subset of symbol locations in the game symbol matrix; and
(b) award a prize for each winning subset combination defined through the game symbol matrix.

17. The program product of claim 15 wherein each winning full window combination requires a respective game symbol of a predefined game symbol type at each game symbol location of the game symbol matrix.

18. The program product of claim 17 wherein the predefined game symbol type includes a particular game symbol graphic representation.

19. The program product of claim 17 wherein the predefined game symbol type includes a particular game symbol color.

20. The program product of claim 15 wherein the game symbol matrix is displayed through a number of reels of a reel-type wagering game and one or more of the reels include a series of adjacent symbols which participate in a respective winning full window combination defined in the first pay table.
